(19) United States
(12) Patent Application Publication
(10) Pub. No.: US 2007/0124588 A1
(43) Pub. Date: May 31, 2007

(54) Information processing device and controlling method thereof

(76) Inventors: Hiroyuki Tsuji, Ome-shi (JP); Hiroshi Aiba, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/601,987

(22) Filed: Nov. 20, 2006

(30) Foreign Application Priority Data
Nov. 30, 2005 (JP) 2005-345384

(51) Int. Cl. H04L 9/00

(52) U.S. Cl. 713/168

(57) ABSTRACT

According to one embodiment, when an input from a pen input device is detected by a sensor, it is discriminated by BIOS that single sign-on is set. If it is discriminated that single sign-on is set, authentication is executed by a fingerprint authentication device. If the authentication is confirmed, an information processing device returns from a power-saving state.

### CROSS-REFERENCE TO RELATED APPLICATIONS

This application is based upon and claims the benefit of priority from Japanese Patent Application No. 2005-345384, filed Nov. 30, 2005, the entire contents of which are incorporated herein by reference.

### BACKGROUND

1. Field

This invention relates to an information processing device capable of returning from a power-saving mode through single sign-on by a pen input device and a control method of the information processing device.

2. Description of the Related Art

According to the technique employing a tablet PC having a pen input function, power supply is restricted unless a signal emitted from the pen is received for more than a set period of time. If a pen input is made while the power supply is restricted, registered authentication information is compared with input authentication information (BIOS authentication). If the registered authentication information matches the input authentication information, the power is supplied (Jpn. Pat. Appln. KOKAI Publication No. 2002-258997).

According to this technique, however, log-in authentication of the operating system needs to be executed after the BIOS authentication, and convenience may be thereby damaged for the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing a structure of a tablet PC to which an information processing device according to a first embodiment of the present invention is applied;

FIG. 2 is an illustration showing a concept of a configuration including a tablet controller employed for return from a power-saving mode under single sign-on control, in the tablet PC shown in FIG. 1;

FIG. 3 is a flowchart showing a method of controlling the information processing device according to the first embodiment of the present invention;

FIG. 4 is an illustration showing a pen input screen to execute authentication by a pen input device; and

FIG. 5 is a perspective view showing a tablet style of the tablet PC.

### DETAILED DESCRIPTION

Various embodiments according to the invention will be described hereinafter with reference to the accompanying-drawings. In general, according to one embodiment of the invention, an information processing device capable of executing the BIOS authentication processing and the log-in authentication of the operating system by one-time authentication under the single sign-on control, and also provide a method of controlling the information processing device. To achieve this object, an aspect of the present invention is an information processing device comprising detection means for detecting an input from pen input means, authentication means, comprising discrimination means for discriminating whether or not single sign-on is set if the input from the pen input means is detected by the detection means in a case where the information processing device is in a power-saving state, authentication processing means for executing authentication by the authentication means if it is discriminated by the discrimination means that the single sign-on is set, and return means for returning the information processing device from the power-saving state if the authentication is confirmed by the authentication processing means.

An embodiment of the present invention will be explained below with reference to the accompanying drawings.

### FIRST EMBODIMENT

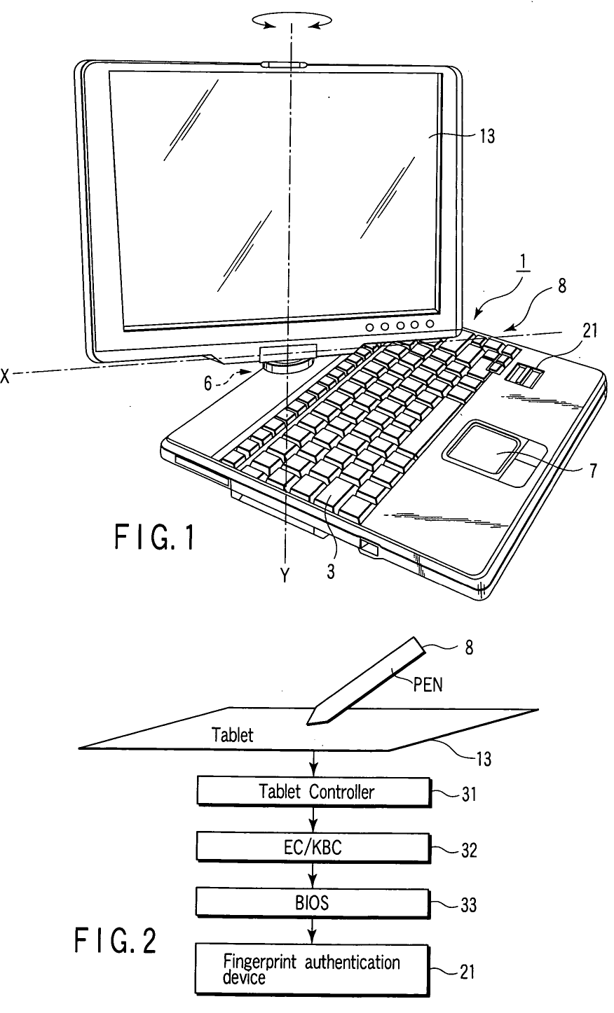

FIG. 1 is a perspective view showing a notebook-type tablet PC as an information processing device according to a first embodiment of the present invention.

A tablet PC 1 is composed of a main body comprising a keyboard 3, a touch pad 7, a fingerprint authentication device 21 and a hinge 6 connecting with a movable liquid-crystal display 13, and the liquid-crystal display 13 movably connected with the hinge 6. In the tablet PC 1, the display 13 is a touch panel. Direct operations can be made on the display 13 with a pen input device 8 such as a stylus pen which can be built in the main body. The display 13 can be rotated at the hinge 6 about the Y axis. The display 13 is also able to fall down about the X axis.

FIG. 2 is an illustration showing a concept of a configuration including a tablet controller employed for return from a power-saving mode under single sign-on control, in the tablet PC.

The tablet PC 1 is composed of the display (tablet) 13 to detect the input from the pen input device 8, a tablet controller 31, an EC/KBC 32, the BIOS 33, the fingerprint authentication device 21, etc.

The pen input device 8 contains, for example, a coil. The display 13 of the tablet PC 1 comprises a pen input sensor (not shown) which detects a location of the coil in the pen input device 8, as sensing means. The tablet controller 31 notifies the EC/KBC 32 of the detection data of the pen input device 8 obtained by the sensing means.

When the EC/KBC 32 receives the signal, the EC/KBC 32 transmits a Wake-Up signal to the BIOS 33. When the BIOS 33 receives the Wake-Up signal, the BIOS 33 activates the operation system and the fingerprint authentication device 21 such that the operation system and the fingerprint authentication device 21 can be employed.

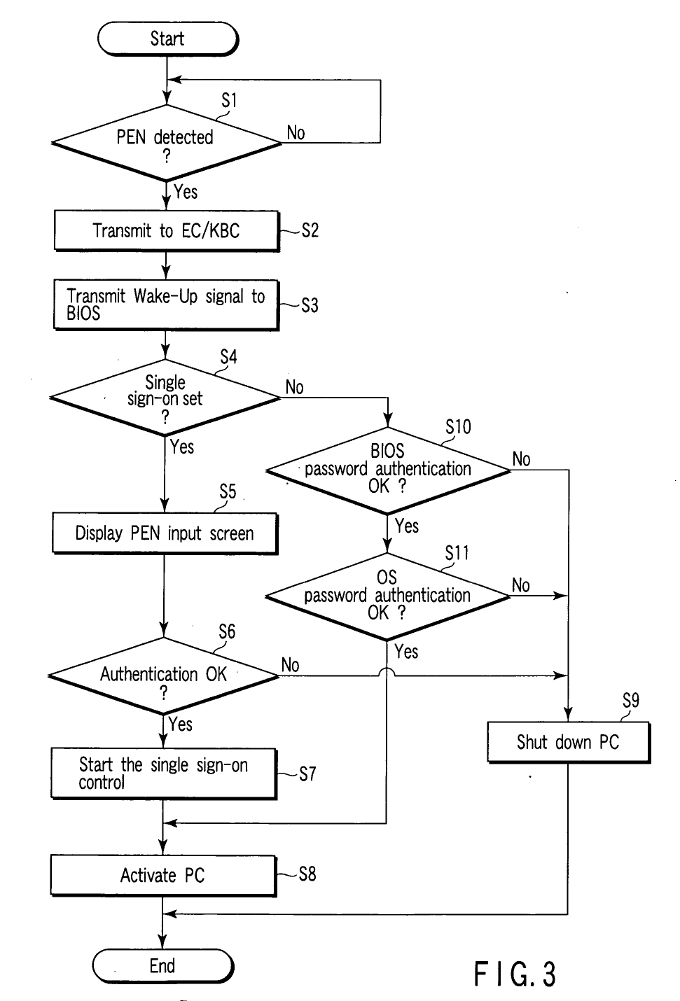

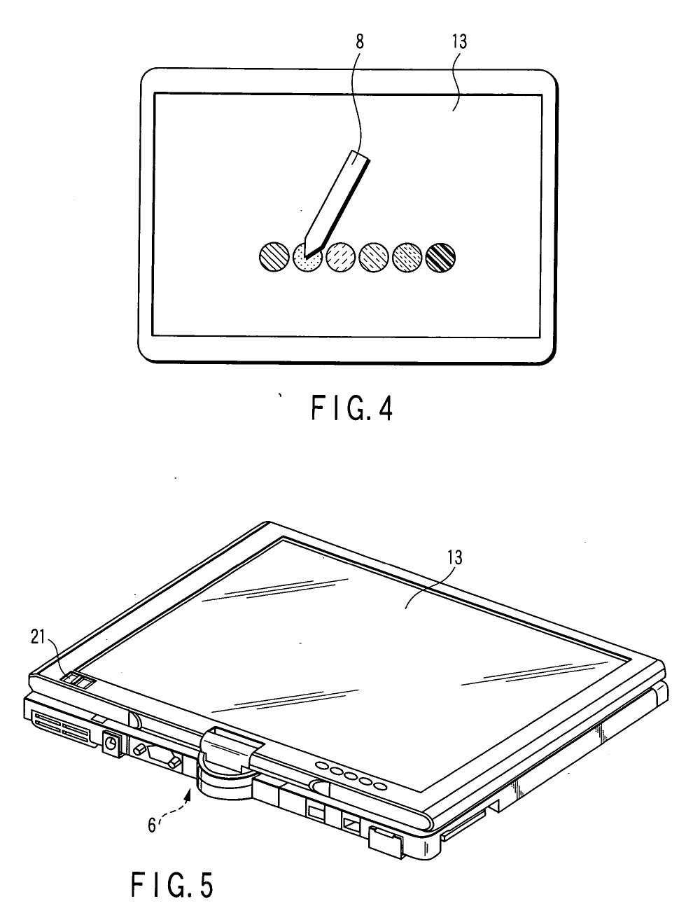

Next, FIG. 3 is a flowchart showing a method of controlling the information processing device according to the first embodiment of the present invention.

When the pen input sensor of the display 13 discriminates that pen input from the pen input device 8 has been detected (YES in step S1), the pen input sensor transmits the detected data of the pen input device 8 to the EC/KBC 32 (step S2).

When the EC/KBC 32 receives the detected data of the pen input device 8, the EC/KBC 32 transmits a Wake-Up signal to the BIOS 33 (step S3). The BIOS 33 discriminates whether or not the single sign-on is set (step S4). If it is discriminated by the BIOS 33 that the single sign-on is set (YES in step S4), the pen input screen is displayed.

On the pen input screen, for example, six colors are displayed and the authentication is conducted by tapping the same color as a preset color.

If the authentication conducted by the pen input device 8 is OK (YES in step S6), the single sign-on control is started by the BIOS 33 (step S7) and the tablet PC 1 is activated (step S8).

On the other hand, if it is discriminated by the BIOS 33 that the single sign-on is not set (NO in step S4), the password input screen is displayed on the display 13 to urge the user to input a BIOS password (step S10). If the BIOS password authentication is OK (YES in step S10), the OS password authentication is confirmed. If the OS password authentication is OK (YES in step S11), the tablet PC 1 is activated (step S8).

If the authentication is not okay in steps S6, S10 and S11, the authentication error is displayed (step S9).

As a modified example of the first embodiment of the present invention, the display 13 can fall down about the X axis. If the display 13 falls down with the display face thereof facing upward, the tablet PC 1 becomes a tablet style as shown in FIG. 5. When the tablet PC 1 is in such a tablet style, for example, two users can watch the display 13.

In this case, the fingerprint authentication device 21 may be provided in the frame of the display 13. Even if the tablet PC 1 is in the tablet style, the authentication can be executed by the fingerprint authentication device 21.

In the conventional password authentication, it is necessary to execute authentication in the BIOS at the time of activating the PC and further execute authentication at the time of log-in to the operation system, i.e. the password needs to be input two times. The single sign-on control requires the password authentication in the BIOS at only one time and the authentication is executed until the log-in to the operation system. In a case where the single sign-on is executed in a device wherein the single sign-on can be executed, various kinds of devices other than the fingerprint authentication device can also be employed.

Moreover, if a number of set colors are displayed or a plurality of colors are selected at the authentication employing the pen input device 8, the reliability of the device capable of the single sign-on can be enhanced. The present invention can also be further developed to applied examples by adding a handwriting recognition technology, etc. to the discrimination program.

Consequently, a high-level security mechanism can be easily implemented in association with the activation of the device capable of the single sign-on, by employing the pen-operated Wake-Up control peculiar to the tablet PC. Furthermore, if the user moves away from the tablet PC 1 while having the pen input device 8 in the user's hand at the time of standing by the Wake-Up of the tablet PC 1, the Wake-Up processing cannot be executed and further enhancement of the easy and simple security can be thereby achieved.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device, comprising:
a detection unit for detecting an input from a pen input unit;
an authentication unit;
a discrimination unit for discriminating whether or not a single sign-on is set if the input from the pen input unit is detected by the detection unit in a case where the information processing device is in a power-saving state;
an authentication processing unit for executing an authentication by the authentication unit if it is discriminated by the discrimination unit that the single sign-on is set; and
a return unit for returning the information processing device from the power-saving state if the authentication is confirmed by the authentication processing unit.

2. The information processing device, according to claim 1, further comprising an operation system and a BIOS that is capable of storing authentication information,
wherein the authentication processing unit is a single sign-on process that can execute authentication of a log-in to the BIOS and the operation system at one time by executing the authentication in accordance with the authentication information stored in the BIOS.

3. The information processing device, according to claim 1, wherein the authentication unit is a fingerprint authentication device.

4. The information processing device, according to claim 1, wherein the authentication unit is an input process employing the pen input unit.

5. The information processing device, according to claim 1, wherein if it is discriminated by the discrimination unit that the single sign-on is not set, the authentication is executed, and
wherein if the authentication is confirmed, the information processing device returns from the power-saving state.

6. The information processing device, according to claim 1, wherein the pen input unit comprises identification information and is configured to be employed in executing the authentication by the authentication unit.

7. A method of controlling an information processing device, comprising a detection unit for detecting an input from a pen input unit and an authentication unit, the method comprising:
discriminating whether or not a single sign-on is set if the input from the pen input unit is detected by the detection unit in a case where the information processing device is in a power-saving state;
executing an authentication by the authentication unit if it is discriminated by the discrimination unit that the single sign-on is set; and
returning the information processing device from the power-saving state if the authentication is confirmed by an authentication processing unit.

8. The method according to claim 7, wherein the information processing device further comprises an operation system and a BIOS that is capable of storing authentication information, and
wherein the authentication processing unit is a single sign-on process that can execute authentication of a log-in to the BIOS and the operation system at one time by executing the authentication in accordance with the authentication information stored in the BIOS.
